(19) United States
(12) Patent Application Publication
(10) Pub. No.: US 2012/0168419 A1
(43) Pub. Date: Jul. 5, 2012

(54) ROOF AND RAIN GUTTER ICE MELT SYSTEM AND ASSEMBLY

(76) Inventor: Gregory S. Bublitz, Delafield, WI (US)

(21) Appl. No.: 13/291,304

(22) Filed: Nov. 8, 2011

Related U.S. Application Data
(60) Provisional application No. 61/429,927, filed on Jan. 5, 2011.

(51) Int. Cl. E04D 13/076; H05B 1/00; E04D 13/064

(52) U.S. Cl. 219/213; 52/11; 52/173.1; 52/12

(57) ABSTRACT

A roof and rain gutter ice melt system and assembly provide a base panel and a cover panel. The base panel is functionally adapted to be mounted at a roof edge at the back wall of a conventional rain gutter. In one embodiment, the base panel also includes means for supporting a heat cable within it. Electrical energization of the heat cable results in the conduction of heat through the base panel and through the cover panel, the cover panel including means of overlapping and engaging the base panel. A second heat cable is disposed in the floor of the rain gutter. In an alternative embodiment, the heat cable is disposed within a roof edge panel. In either alternative embodiment, a front panel can be provided to allow the front lip of the rain gutter to be heated atop a metal gutter screen.

This application claims the benefit and priority of U.S. Provisional Patent Application No. 61/429,927 filed Jan. 5, 2011.

### FIELD OF THE INVENTION

This invention relates generally to devices, systems, assemblies and methods that are used to prevent snow and ice build-up from occurring in and around rain gutters that are mounted to the roof edges of a building. More specifically, it relates to a snow and ice melting system and assembly that can be installed at a conventional roof edge rain gutter to prevent the build-up of snow and ice near the gutter, the device using electric energy that is converted to heat to melt the snow and ice as it falls onto or advances toward the roof edge and rain gutter.

### BACKGROUND OF THE INVENTION

A number of static and dynamic factors can combine to create ice dams at the edge of a roof. Such factors include the way that the roof is constructed and insulated, both of which impact the amount of heat loss that is created at the roof edge via heat conduction and convection. Other factors typically include snowfall amounts, snow cover amounts, outside temperatures and radiation, or the exposure of the roof and roof edge to direct sunlight, or the absence of such exposure.

Where the factors mentioned above cannot be controlled, a roof and rain gutter ice melt system and assembly can be used to eliminate such ice dams, or to prevent creation of an ice dam in the first instance. In the experience of this inventor, a number of configurations have been used to accomplish the intended purpose of eliminating or preventing ice dams. Some configurations, though effective, are often complex in construction which makes them potentially expensive to fabricate and also expensive to install. Some configurations are also relatively expensive to operate due to inherent inefficiencies in the system or assembly.

In the view of this inventor, there is a need for a simplified system and assembly that provides the functionality of eliminating or preventing ice dams and that is also relatively simple in construction and installation. In the experience of this inventor, such a system and assembly exists and is the subject of the present invention.

### SUMMARY OF THE INVENTION

The roof and rain gutter ice melt system and assembly of the present invention provides a base panel and a cover panel. The base panel is functionally adapted to be mounted at a roof edge at the back wall of a conventional rain gutter, although the base panel could be used at a roof edge without a gutter. The base panel also includes means for supporting a heat cable within it. Electrical energization of the heat cable results in the conduction of heat through the base panel and through the cover panel, the cover panel including means of overlapping and engaging the base panel. A second heat cable is disposed in the floor of the rain gutter. In an alternative embodiment, the structure for supporting the heat cable within the base panel is configured differently from the first embodiment. In yet another alternative embodiment, a front panel is provided to allow the front lip of the rain gutter to be heated atop a metal gutter screen.

In all of the embodiments, it is desirable that the system and assembly be energized with electrical energy using one or more self-regulating heated cables.

The foregoing and other features of the present invention will be apparent from the detailed description that follows.

### BRIEF DESCRIPTION OF THE DRAWINGS

FIG. 1 is a side elevational and cross-sectioned view of a first preferred embodiment of the roof and rain gutter ice melt system and assembly that is constructed in accordance with the present invention, and showing the components as they would be used within a rain gutter of conventional manufacture that is mounted at the roof edge of a building.

FIG. 2 is a side elevational and cross-sectioned view of a second preferred embodiment of the roof and rain gutter ice melt system and assembly that is constructed in accordance with the present invention, also showing the components as they would be used within a rain gutter of conventional manufacture that is mounted at the roof edge of a building.

### DETAILED DESCRIPTION

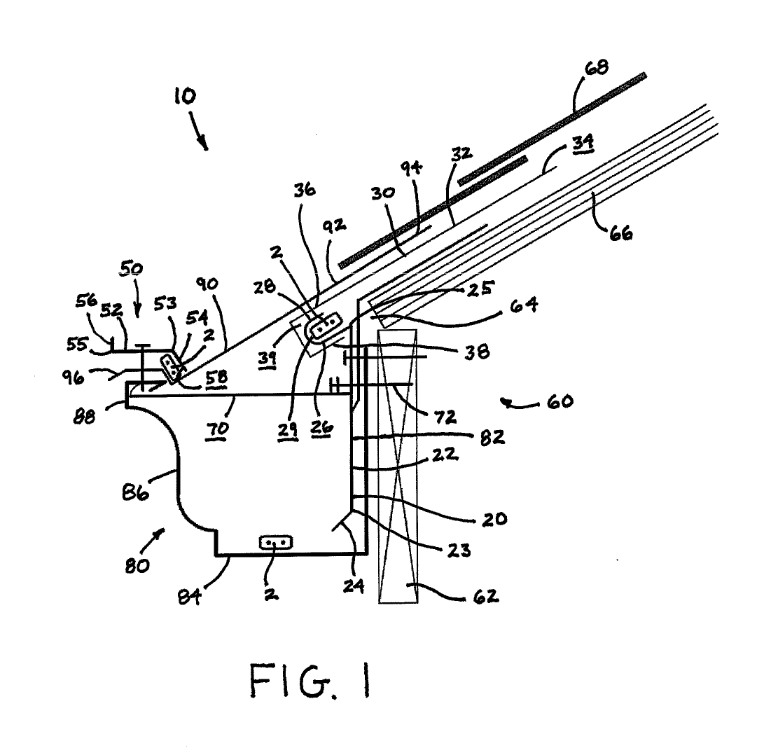

Referring now to the drawings in detail wherein like numbers represent like elements throughout, FIG. 1 illustrates a first preferred embodiment of a system and assembly as they would be constructed in accordance with the present invention. Although each component is shown in a cross-sectioned format, it is to be understood that each component comprises a longitudinally-extending and substantially sheet-like structure, or panel, a portion of which is configured to have a self-regulating heat cable supported by it or within it. In the first preferred embodiment, each panel is further designed to be a unitary structure that is fabricated of a metal material such that the heat-transferring capability of the panel is maximized.

FIG. 1 illustrates a number of discrete elements or components of the system and assembly, generally identified 10, as used together in the first preferred embodiment of the present invention. It is to be understood that the numeral 10 references both the system and the assembly, but that the word “assembly” will be used for the balance of this detailed description to describe both the system and the assembly of the present invention.

The first discrete element is an integrally-formed and longitudinally-extending base panel, generally identified 20. As formed, the base panel 20 can be a metal extrusion or other sheet metal structure having a back portion 22, a downwardly and forwardly extending bottom lip portion 24 and a downwardly and forwardly extending top lip portion 26. The bottom lip portion 24 is created by a bend 23 that is formed in the back portion 22. The top lip portion 26 is created by a bend 25 that is formed in the back portion 22 and by a portion 28 that is bent upwardly and rearwardly in a curved configuration to overlay the top lip portion 26. The bend 25 can be made in the shop, during fabrication, or in the field, during installation, to match the pitch of the roof that the assembly 10 will be used with, which will be apparent later in this detailed description. A cavity 29 is formed within the curved portion 28 of the top lip portion 26. In the preferred embodiment, this cavity 29 is used to retain and to run a self-regulating heat cable 2 along the length of the base panel 20. The cavity 29 further serves to protect the heat cable 2 from exposure and potential damage.

Another element of the assembly 10 is an integrally-formed and longitudinally-extending cover panel, generally identified 30, which is also illustrated in FIG. 1. The cover panel 30 can be a metal extrusion or may be fabricated of formed sheet metal material. The cover panel 30 comprises a substantially flat central portion 32 having an upper edge portion 34 and a lower edge portion 36. The lower edge 36 further comprises a rearwardly bent portion 38, the bent portion 38 being bent in a downwardly and rearwardly curved configuration to underlay the lower edge portion 36 of the cover panel 30 to form a cavity 39 within it. The bent portion 38 of the lower edge portion 36 is intended, in the first preferred embodiment, to overlay the bent portion 28 of the top lip portion 26 of the base panel 20, the back panel cavity 29 supporting the cable 2.

FIG. 1 further illustrates another element of the assembly 10 which is an integrally-formed and also longitudinally-extending front panel, generally identified 50. The front panel 50 is functionally adapted to be attached to the forward lip of a rain gutter. The front panel 50 can similarly be a metal extrusion or formed sheet metal part of the assembly 10. The front panel 50 comprises a flat central portion 52, a downwardly and forwardly extending bottom lip portion 54 and an upwardly extending top lip portion 56. The bottom lip portion 54 is formed by a bend 53 that is formed in the central portion 52 and the top lip portion 56 is formed by another bend 55 that is formed in the central portion 52. The bottom lip portion 54 comprises an underside 58 and a self-regulating heat cable 2 that is secured to the underside 58, which cable 2 runs along the length of the front panel 50. The bottom lip portion 54 serves to protect the heat cable 2.

In application, the assembly 10 of the first preferred embodiment of the present invention comprises the previously-discussed elements of the base panel 20 and the cover panel 30. Although the front panel 50 element is illustrated in FIG. 1, it is to be understood that its inclusion comprises an alternative embodiment of the first preferred embodiment of the assembly 10 of the present invention. As shown, the assembly 10 is attachable to a rain gutter 80 of conventional manufacture, the rain gutter 80 typically being a longitudinally-extending structure that is attachable to the roof edge 64 of a building 60. It should be mentioned here, however, that the assembly 10 of the present invention could also be used at a roof edge 64 that does not have a rain gutter 80 attached to it.

In the embodiment shown in FIG. 1, the building 60 comprises a vertical building element 62, the roof edge 64 which presents at an angle relative to the horizontal, a roof deck 66 and shingles 68. The rain gutter 80 is of conventional manufacture and comprises a back wall 82, a floor 84 and a front wall 86, the front wall terminating at a lip 88. The rain gutter 80 is further supported by a hanger 70 and a fastener 72, also of conventional manufacture.

With the rain gutter 80 secured to the vertical building element 62 by means of the hanger 70 and fastener 72, the base panel 20 of the assembly 10 is concomitantly secured by its back portion 22 to the back wall 82 of the rain gutter and, in turn, to the vertical building element 62. The bottom lip portion 24 of the base panel 20 extends down into the rain gutter 80 and the top lip portion 26 extends above it. The cover panel 30 is then secured to the roof deck 66, beneath the shingles 68, such that the cavity 39 of the lower edge portion 36 of the cover panel 30 effectively captures the top lip portion 26 and the curved portion 28 of the base panel 20. In this configuration, and with the heat cable 2 being actuated, ice buildup is prevented along the roof edge 64. With a heat cable 2 secured to the floor 84 of the rain gutter 80, water is also not allowed to re-freeze within the rain gutter 80.

In an alternative embodiment, the assembly 10 is provided with a gutter screen 90, which is also a longitudinally-extending structure that runs along the roof edge 64 atop the rain gutter 80. The gutter screen 90 has a flat central portion 92, an upwardly extending roof edge portion 94 and a downwardly extending gutter edge portion 96. As shown in FIG. 1, the gutter edge portion 96 can be secured to the lip 88 of the gutter 80 with the front panel 50 disposed on top of it. This configuration effectively captures the heat cable 2 between those structures, thereby protecting the cable 2 and preventing ice buildup along the gutter screen 90 at the outer gutter lip 88.

It is to be understood that the self-regulating heat cable 2 that is used in the present invention is not, by itself, novel. Indeed, such cable 2 is well known in the art. When combined with or used in the assembly 10 of the present invention, however, such cable 2 comprises means for regulating the temperature of the cable 2 as needed via a control component which may be pre-programmable. This maximizes performance of the assembly 10 and conserves the use of electrical energy by it.

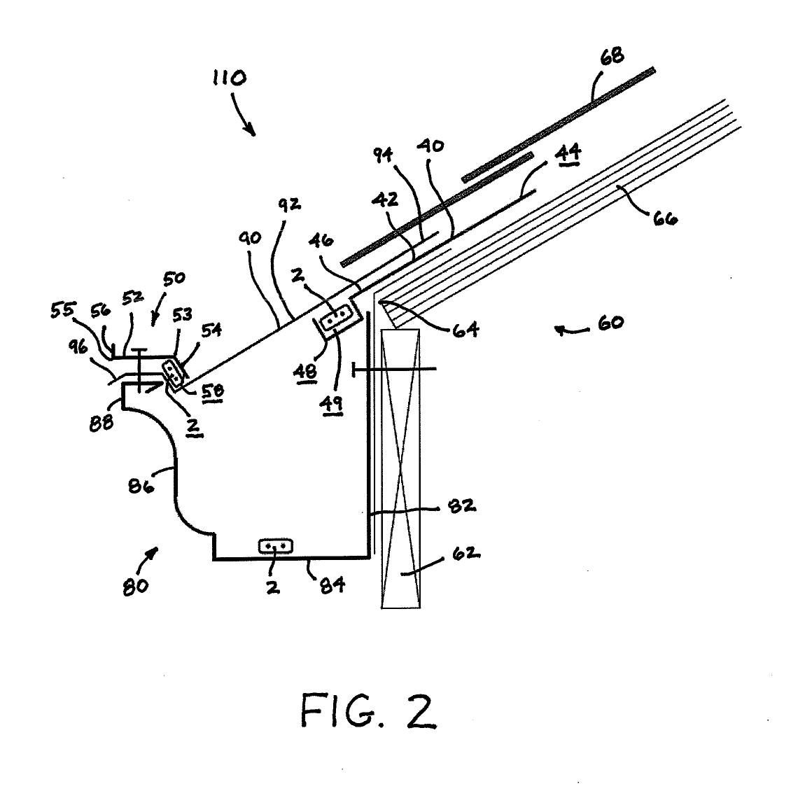

Referring now to FIG. 2, it illustrates a second preferred embodiment of the assembly 110 of the present invention. The assembly 110 notably does not comprise the previously-discussed elements of the base panel 20 and the cover panel 30. Instead, the assembly 110 comprises a roof edge panel 40. As shown, the assembly 110 is similarly attached to a rain gutter 80, the rain gutter 80 being a longitudinally-extending structure that is attached to the roof edge 64 of a building 60. Again, the assembly 110 of the present invention could, however, be used at a roof edge 64 that does not have a rain gutter 80 attached to it.

In the embodiment shown in FIG. 2, the building 60 comprises the vertical building element 62, the roof edge 64 which presents at an angle relative to the horizontal, the roof deck 66 and the shingles 68. The rain gutter 80 comprises a back wall 82, a floor 84 and a front wall 86, the front wall terminating at a lip 88. The rain gutter 80 is further supported by a hanger (not shown) and a fastener (also not shown) of conventional manufacture.

As with the first preferred embodiment, it should be noted that the inclusion of the front panel 50 element as illustrated in FIG. 2 comprises an alternative embodiment of the second preferred embodiment of the assembly 110.

Referring again to the integrally-formed roof edge panel 40, FIG. 2 shows that the roof edge panel 40 comprises a substantially flat central portion 42 having an upper edge portion 44 and a lower edge portion 46. The lower edge 46 further comprises a bent portion 48, the bent portion 48 being bent in a downwardly and then upwardly bent configuration to form a cavity 49 within it. A self-regulating heat cable 2 as previously described is contained within this cavity 49. With the rain gutter 80 secured to the vertical building element 62, the roof edge panel 40 of the assembly 110 is secured to the roof deck 66, beneath the shingles 68, such that the cavity 49 of the lower edge portion 46 of the roof edge panel 40 extends away from the roof deck 66. In this configuration, and with the heat cable 2 being actuated, ice buildup is prevented along the roof edge 64. With a heat cable 2 secured to the floor 84 of the rain gutter 80, water is also not allowed to re-freeze within the rain gutter 80.

In an alternative embodiment of the assembly 110 that is shown, the assembly 110 is provided with a gutter screen 90, which is also a longitudinally-extending structure that runs along the roof edge 64 atop the rain gutter 80. The gutter screen 90 has a flat central portion 92, an upwardly extending roof edge portion 94 and a downwardly extending gutter edge portion 96. As shown in FIG. 2, the gutter edge portion 96 can be secured to the lip 88 of the gutter 80 with the front panel 50 disposed on top of it. This configuration effectively captures the heat cable 2 between those structures, thereby protecting the cable 2 and preventing ice buildup along the gutter screen 90 at the outer gutter lip 88.

In view of the foregoing, it will be apparent that there has been provided a new, useful and non-obvious system and assembly that provides the functionality of eliminating or preventing ice dams at a roof edge and that is also relatively simple in its construction and installation.

The details of the invention having been disclosed in accordance with the foregoing, I claim:

1. A roof and gutter ice melt assembly comprising:
a base panel, the base panel comprising a cavity;
a self-regulating first heat cable, the first heat cable being retained within the base panel cavity; and
a cover panel, a portion of the cover panel covering the base panel cavity and heat cable retained therein.

2. The roof and gutter ice melt assembly of claim 1 wherein the base panel further comprises a back portion, a downwardly and forwardly extending bottom lip portion and a downwardly and forwardly extending top lip portion, the top lip portion forming the heat cable cavity.

3. The roof and gutter ice melt assembly of claim 2 wherein the cover panel further comprises a substantially flat central portion having an upper edge portion and a lower edge portion, the lower edge portion forming a downwardly and rearwardly curved structure to overlay the top lip portion of the base panel and heat cable cavity.

4. The roof and gutter ice melt assembly of claim 3 further comprising:
a front panel, the front panel comprising a flat central portion and a bottom lip portion, the bottom lip portion comprising an underside; and
a self-regulating second heat cable, the second heat cable being secured to the underside of the bottom lip portion of the front panel.

5. The roof and gutter ice melt assembly of claim 4 further comprising a gutter screen.

6. A roof and gutter ice melt assembly comprising:
a roof edge panel, the roof edge panel comprising a cavity; and
a self-regulating first heat cable, the first heat cable being retained within the roof edge panel cavity.

7. The roof and gutter ice melt assembly of claim 6 wherein the roof edge panel further comprises a back portion, a downwardly and forwardly extending bottom lip portion, the bottom lip portion forming the heat cable cavity.

8. The roof and gutter ice melt assembly of claim 7 further comprising:
a front panel, the front panel comprising a flat central portion and a bottom lip portion, the bottom lip portion comprising an underside; and
a self-regulating second heat cable, the second heat cable being secured to the underside of the bottom lip portion of the front panel.

9. The roof and gutter ice melt assembly of claim 8 further comprising a gutter screen.

10. An ice melt assembly for use with a roof edge of a building and a rain gutter attached to the roof edge, the roof edge presenting at an angle relative to the horizontal, a roof deck, shingles and a vertical building element, and a rain gutter attached to the building roof edge and comprising a back wall, a floor and a front wall, the front wall terminating at a lip, the assembly comprising:
a base panel, the base panel comprising a cavity;
a self-regulating first heat cable, the first heat cable being retained within the base panel cavity; and
a cover panel, a portion of the cover panel covering the base panel cavity and heat cable retained therein.

11. The ice melt assembly of claim 10 wherein the base panel further comprises
a back portion that is secured to the vertical building element and extends downwardly along the back wall of the rain gutter and into the rain gutter;
a downwardly and forwardly extending bottom lip portion; and
a downwardly and forwardly extending top lip portion, the top lip portion forming the heat cable cavity.

12. The ice melt assembly of claim 11 wherein the cover panel further comprises a substantially flat central portion having an upper edge portion and a lower edge portion, the lower edge portion forming a downwardly and rearwardly curved structure to overlay the top lip portion of the base panel and heat cable cavity.

13. The ice melt assembly of claim 12 further comprising:
a front panel, the front panel comprising a flat central portion and a bottom lip portion, the bottom lip portion comprising an underside; and
a self-regulating second heat cable, the second heat cable being secured to the underside of the bottom lip portion of the front panel;
wherein the front panel is secured to the lip of the rain gutter.

14. The ice melt assembly of claim 13 further comprising a gutter screen.

15. An ice melt assembly for use with a roof edge of a building and a rain gutter attached to the roof edge, the roof edge presenting at an angle relative to the horizontal, a roof deck, shingles and a vertical building element, and a rain gutter attached to the building roof edge and comprising a back wall, a floor and a front wall, the front wall terminating at a lip, the assembly comprising:
a roof edge panel, the roof edge panel comprising a cavity; and
a self-regulating first heat cable, the first heat cable being retained within the roof edge panel cavity.

16. The ice melt assembly of claim 15 wherein the roof edge panel further comprises a back portion, a downwardly and forwardly extending bottom lip portion, the bottom lip portion forming the heat cable cavity, the back portion of the roof edge panel being secured to the roof deck and the heat cable cavity extending past the back wall of the rain gutter.

17. The ice melt assembly of claim 16 further comprising:
a front panel, the front panel comprising a flat central portion and a bottom lip portion, the bottom lip portion comprising an underside; and
a self-regulating second heat cable, the second heat cable being secured to the underside of the bottom lip portion of the front panel;
wherein the front panel is secured to the lip of the rain gutter.

18. The ice melt assembly of claim 17 further comprising a gutter screen.
